(19) United States
(12) Patent Application Publication
(10) Pub. No.: US 2025/0183473 A1
(43) Pub. Date: Jun. 5, 2025

(54) BATTERY DEVICE AND COMBUSTION SUPPRESSION METHOD THEREOF

(71) Applicant: Chunghwa Telecom Co., Ltd., Taoyuan City (TW)

(72) Inventors: Ching-Po Lin, Taoyuan City (TW); Yaw-Tzong Horng, Taoyuan City (TW); Kuo-Hsiang Lai, Taoyuan City (TW)

(73) Assignee: Chunghwa Telecom Co., Ltd., Taoyuan City (TW)

(21) Appl. No.: 18/419,559

(22) Filed: Jan. 23, 2024

(30) Foreign Application Priority Data
Dec. 5, 2023 (TW) 112147318

(51) Int. Cl. H01M 50/383; A62C 3/06; A62C 3/16; A62C 4/00; H01M 10/052; H01M 50/204; H01M 50/244

(52) U.S. Cl. CPC H01M 50/383; A62C 3/06; A62C 3/16; A62C 4/00; H01M 50/204; H01M 50/244; H01M 10/052

(57) ABSTRACT

A battery device includes a casing, a cell module, and a catalytic converter. The casing has an interior space. The cell module is arranged in the internal space. The catalytic converter is arranged in the internal space and separates the cell module from an external space relative to the internal space. A combustion suppression method of battery device is also provided.

### CROSS-REFERENCE TO RELATED APPLICATION

This application claims the priority benefit of Taiwan application serial no. 112147318, filed on Dec. 5, 2023. The entirety of the above-mentioned patent application is hereby incorporated by reference herein and made a part of this specification.

### BACKGROUND

### Technical Field

The application relates to a battery device and a combustion suppression method thereof.

### Description of Related Art

In general, when batteries fail, they may burn and produce flames and high concentrations of combustible gases (such as carbon monoxide (CO), hydrocarbons (HC), etc.). If the battery cannot be effectively controlled, it will easily have adverse effects on the equipment around the battery and may also cause safety concerns for the people around the battery.

### SUMMARY

The present invention provides a battery device and a combustion suppression method thereof, which can effectively reduce the probability that equipment and personnel in external spaces being harmed after combustion.

The battery device of the present invention includes a casing, a cell module, and a catalytic converter. The casing has an interior space. The cell module is arranged in the internal space. The catalytic converter is arranged in the internal space and separates the cell module from an external space relative to the internal space.

In an embodiment of the present invention, the above-mentioned catalytic converter comprises a cubic pore structure or a honeycomb pore structure.

In an embodiment of the present invention, the above-mentioned catalytic converter comprises a binary catalytic catalyst or a three-way catalytic catalyst.

In an embodiment of the present invention, the material of the above-mentioned catalytic converter comprises a ceramic coated with precious metal.

In an embodiment of the present invention, the above-mentioned cell module comprises a lithium ternary battery module or a lithium iron phosphate battery module.

In an embodiment of the present invention, the above-mentioned casing has an entry end and an exit end. The catalytic converter comprises a first catalytic converter and a second catalytic converter. The first catalytic converter is arranged between the cell module and the entry end, and the second catalytic converter is arranged between the cell module and the exit end.

In an embodiment of the present invention, the above-mentioned first catalytic converter is in direct contact with the casing on both sides and the second catalytic converter is in direct contact with the casing on both sides to form a closed space surrounding the cell module.

In an embodiment of the present invention, the above-mentioned casing does not have an opening. The catalytic converter is a closed ring structure to form a closed space surrounding the cell module.

In an embodiment of the present invention, the above-mentioned catalytic converter has no contact with the casing.

The combustion suppression method of battery device of the present invention at least includes the following steps. The operation of battery device produces flames and combustible gases, wherein the battery device includes a casing, a cell module, and a catalytic converter. The casing has an interior space. The cell module is arranged in the internal space. The catalytic converter is arranged in the internal space and separates the cell module from an external space relative to the internal space. The flames and the combustible gases pass through the catalytic converter.

Based on the above, the catalytic converter in the battery device of the present invention can serve as a flame blocking element and a gas conversion element at the same time. In this way, the flames and the combustible gases generated by the combustion of the cell module can be effectively controlled to achieve a suppression effect, which can effectively reduce the probability of equipment and personnel in the external space being harmed after combustion.

In order to make the above-mentioned features and advantages of this case more obvious and easier to understand, embodiments are given below and explained in detail with the accompanying drawings.

### BRIEF DESCRIPTION OF THE DRAWINGS

FIG. 1 is a schematic structural diagram of a battery device according to an embodiment of the present invention.

FIG. 2 is an enlarged schematic diagram of the catalytic converter of FIG. 1.

FIG. 3 is a schematic structural diagram of a battery device according to another embodiment of the present invention.

### DESCRIPTION OF THE EMBODIMENTS

In the following detailed description, for purposes of illustration and not limitation, exemplary embodiments disclosing specific details are set forth in order to provide a thorough understanding of the various principles of the present invention. However, it is obvious to those skilled in the art having the benefit of the disclosure, that the present invention may be practiced in other embodiments departing from the specific details disclosed herein. Additionally, descriptions of well-known devices, methods, and materials may be omitted so as not to obscure the various principles of the present invention.

Exemplary embodiments of the present invention will be fully described below with reference to the accompanying drawings, but the invention may also be embodied in many different forms and should not be construed as limited to the embodiments set forth herein. The thickness, size, or dimensions of layers or regions in the drawings may be exaggerated for clarity. The same or similar reference numbers indicate the same or similar components and will not be repeated one by one in the following paragraphs.

Unless otherwise defined, all terms (including technical and scientific terms) used herein have the same meaning as commonly understood by those skilled in the art of the present invention.

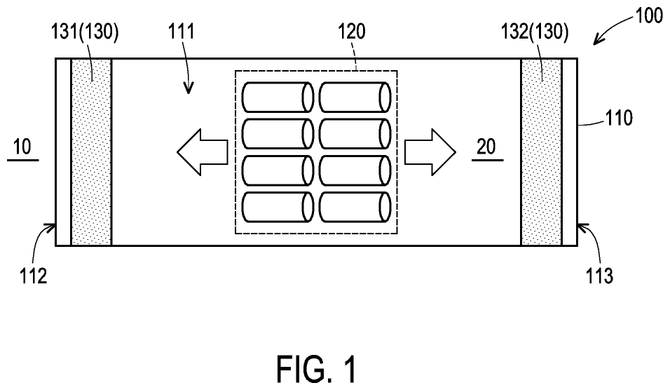

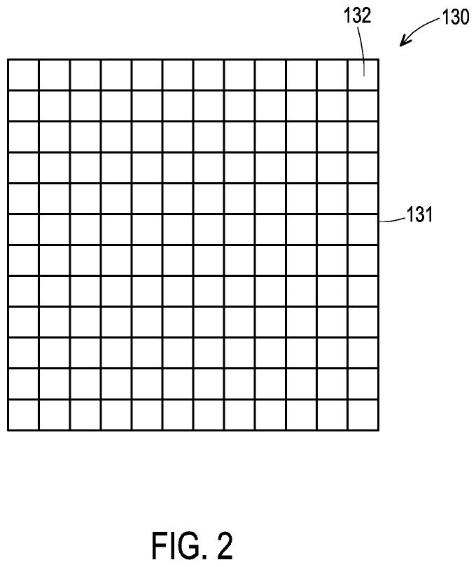

FIG. 1 is a schematic structural diagram of a battery device according to an embodiment of the present invention. FIG. 2 is an enlarged schematic diagram of the catalytic converter of FIG. 1. Referring to FIG. 1 and FIG. 2, the battery device 100 of the embodiment includes a casing 110, a cell module 120 and a catalytic converter 130, wherein the casing 110 has an interior space 111, and the cell module 120 is arranged in the internal space 111. In addition, the catalytic converter 130 is arranged in the internal space 111 and separates the cell module 120 from an external space 10 relative to the internal space 111. Therefore, the catalytic converter 130 in the battery device 100 of the embodiment can serve as a flame blocking element and a gas conversion element at the same time. In this way, the flames and the combustible gases (as shown by the arrow in FIG. 1) generated by the combustion of the cell module 120 can be effectively controlled to achieve a suppression effect, which can effectively reduce the probability of equipment and personnel (not shown) in the external space 10 being harmed after combustion. Here, the internal space 111 and the external space 10 are physically separated by the casing 110.

For example, as shown in FIG. 2, the catalytic converter 130 can be a porous structure formed by a substrate 131 and a plurality of pores 132 thereon, and the surface of the pores 132 is coated with precious metal as a catalyst. In this way, when the flame passes through the catalytic converter 130, the flame structure can be destroyed which causes the air flow to be discontinuous, thereby slowing down the fire or extinguishing the flame. Therefore, it can be used as a flame blocking element. On the other hand, when the combustible gases pass through the catalytic converter 130, the combustible gases produced by the internal chemical reaction can be converted using the catalytic mechanism. For example, hydrocarbons (HC) and carbon monoxide (CO) are converted into carbon dioxide (CO2) and water (H2O) to reduce the concentration of the combustible gases and prevent the spread of fire. Therefore, it can be used as a gas conversion element. In this way, the catalytic converter 130 can inhibit combustion in many aspects (such as through physical barrier and chemical catalysis), and the water produced in the process can also achieve the cooling effect of the internal space 111.

In some embodiments, the catalytic converter 130 is a cubic pore structure as shown in FIG. 2, but the present invention is not limited thereto. The catalytic converter 130 can also be a honeycomb pore structure or porous structures formed by other suitable shapes.

In some embodiments, the catalytic converter 130 is a binary catalytic catalyst (oxidation catalytic catalyst) or a three-way catalytic catalyst. These materials can be obtained by recycling discarded catalytic converters installed in automobile and motorcycle exhaust emission systems and through any re-purification process known to those skilled in the art. Therefore, the catalytic converter 130 can be regarded as a recycled catalytic catalyst. In this way, the battery device 100 using the recycled catalytic catalyst can further have environmental protection effects, wherein the present invention does not limit the specific material composition and structure of the catalytic converter 130. In other words, it can be determined based on the actual discarded catalytic converters taken from the automobile and motorcycle exhaust emission systems or the actual design application. As long as it can separate the cell module 120 and the external space 10 to achieve the functions of flame blocking and gas conversion, it falls within the protection scope of the present invention.

For example, the material of the catalytic converter 130 includes a ceramic coated with precious metal, wherein the ceramic includes silicon oxide, aluminum oxide, cerium oxide or combinations thereof, and the precious metal includes palladium (Pd), platinum (Pt), rhodium (Rh) or combinations thereof. The ceramic can be used as a carrier, and the precious metal can be used as an active catalyst. For example, platinum and palladium are oxidation catalysts, and rhodium is a reduction catalyst to effectively convert combustible gases, but the present invention is not limited thereto. The catalytic converter 130 can use other suitable materials that are porous and capable of converting combustible gases.

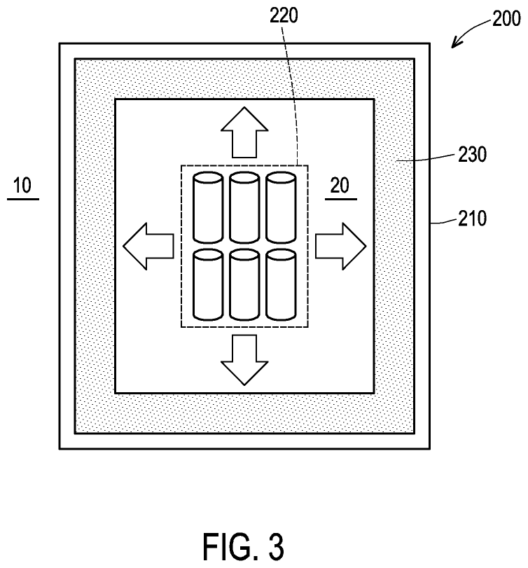

In some embodiments, the cell module 120 is a module composed of multiple cells connected in series, and the cell module 120 can be of a type that is more likely to burn internally. For example, the cell module 120 includes a lithium ternary cell module or a lithium iron phosphate cell module, but the present invention is not limited thereto. The cell module 120 can also be other batteries or electric energy storage devices with combustion risks (thermal runaway probability). In addition, the casing 110 can be selected according to the actual application needs. It should be noted that the present invention does not limit the number of series-connected cells in the cell module. For example, FIG. 1 schematically shows that the cell module 120 includes 8 cells, and FIG. 3 schematically shows that the cell module 220 includes 6 cells.

For example, the lithium ternary cell is a ternary polymer whose positive electrode material includes lithium nickel cobalt manganate, lithium nickel cobalt aluminate or the like, wherein “ternary” refers to a polymer containing any three metal elements including nickel, cobalt, manganese, and aluminum. And the lithium iron phosphate cell uses lithium iron phosphate (LiFePO₄) as the positive electrode material, but the present invention is not limited thereto.

In the embodiment, as shown in FIG. 1, the casing 110 has an entry end 112 and an exit end 113, and the catalytic converter 130 includes a first catalytic converter 131 and a second catalytic converter 132. Wherein, the first catalytic converter 131 is arranged between the cell module 120 and the entry end 112, and the second catalytic converter 132 is arranged between the cell module 120 and the exit end 113. Since the air flow may flow in the direction of low pressure, the generated flames and combustible gases may naturally be driven through the first catalytic converter 131 and the second catalytic converter 132 at the entry end 112 and the exit end 113, thereby achieving the effects of flame blocking and gas conversion.

In some embodiments, in order to effectively prevent flames from escaping from the gap of the casing 110 connected to the outside world, the first catalytic converter 131 is in direct contact with the casing 110 on both sides and the second catalytic converter 132 is in direct contact with the casing 110 on both sides to form a closed space 20 surrounding the cell module 120. Wherein, the volume of the closed space 20 is smaller than the volume of the internal space 111, that is, the closed space 20 is included in the internal space 111, but the present invention is not limited thereto.

Here, it must be noted that the following embodiments follow the component numbers and part of the content of the above-mentioned embodiments. Wherein, the same or similar numbers are used to represent the same or similar elements, and the description of the same technical content is omitted. For omitted parts of the description, reference may be made to the foregoing embodiments, and the following embodiments will not be repeated.

Referring to FIG. 3, compared with the battery device 100 of FIG. 1, the casing 210 of the battery device 200 of the embodiment does not have an opening (such as the outer structure of a suitable power bank), wherein the catalytic converter 230 is a closed ring structure to form a closed space 20 surrounding the cell module 220. Therefore, the catalytic converter 230 in the battery device 200 of the embodiment can serve as a flame blocking element and a gas conversion element at the same time. In this way, the flames and the combustible gases (as shown by the arrow in FIG. 2) generated by the combustion of the cell module 220 can be effectively controlled to achieve a suppression effect, which can effectively reduce the probability of equipment and personnel (not shown) in the external space 10 being harmed after combustion.

In the embodiment, the catalytic converter 130 has no contact with the casing 110. In other words, the catalytic converter 130 is retracted within the casing 110, but the present invention is not limited thereto.

In summary, the catalytic converter in the battery device of the present invention can serve as a flame blocking element and a gas conversion element at the same time. In this way, the flames and the combustible gases generated by the combustion of the cell module can be effectively controlled to achieve a suppression effect, which can effectively reduce the probability of equipment and personnel in the external space being harmed after combustion.

Although the present invention has been disclosed with reference to the embodiments, it is not intended to limit the present invention. Those skilled in the art may make some modifications and refinements within the spirit and scope of the present invention. Therefore, the scope of protection of the present invention shall be determined by the appended claims.

What is claimed is:

1. A battery device, comprising:
a casing, has an interior space;
a cell module, arranged in the internal space; and
a catalytic converter, arranged in the internal space and separates the cell module from an external space relative to the internal space.

2. The battery device according to claim 1, wherein the catalytic converter comprises a cubic pore structure or a honeycomb pore structure.

3. The battery device according to claim 1, wherein the catalytic converter comprises a binary catalytic catalyst or a three-way catalytic catalyst.

4. The battery device according to claim 1, wherein the material of the catalytic converter comprises a ceramic coated with precious metal.

5. The battery device according to claim 1, wherein the cell module comprises a lithium ternary cell module or a lithium iron phosphate cell module.

6. The battery device according to claim 1, wherein the casing has an entry end and an exit end, the catalytic converter comprises a first catalytic converter and a second catalytic converter, and the first catalytic converter is arranged between the cell module and the entry end, the second catalytic converter is arranged between the cell module and the exit end.

7. The battery device according to claim 6, wherein the first catalytic converter is in direct contact with the casing on both sides and the second catalytic converter is in direct contact with the casing on both sides to form a closed space surrounding the cell module.

8. The battery device according to claim 1, wherein the casing does not have an opening, the catalytic converter is a closed ring structure to form a closed space surrounding the cell module.

9. The battery device according to claim 8, wherein the catalytic converter has no contact with the casing.

10. A combustion suppression method of battery device, comprising:
producing flames and combustible gases through the operation of a battery device, wherein the battery device comprises:
a casing, has an interior space;
a cell module, arranged in the internal space; and
a catalytic converter, arranged in the internal space and separates the cell module from an external space relative to the internal space; and
the flames and the combustible gases pass through the catalytic converter.
